(19) United States
(12) Patent Application Publication
(10) Pub. No.: US 2002/0035605 A1
(43) Pub. Date: Mar. 21, 2002

(54) Use of presence and location information concerning wireless subscribers for instant messaging and mobile commerce

(76) Inventors: Mark McDowell, Alexandria, VA (US); Joseph Khalil, Alexandria, VA (US); Steven Zweifach, Alexandria, VA (US); Graham Stead, Arlington, VA (US); David LeJeune JR., Herndon, VA (US)

Correspondence Address: Roberts Abokhair & Mardula, LLC, 11800 Sunrise Drive, Suite 1000, Reston, VA, 20191-5302, US

(21) Appl. No.: 09/810,114

(22) Filed: Mar. 16, 2001

Related U.S. Application Data
(63) Continuation-in-part of application No. 09/771,201, filed on Jan. 26, 2001.
(60) Provisional application No. 60/178,142, filed on Jan. 26, 2000.
(60) Provisional application No. 60/268,977, filed on Feb. 15, 2001.

(51) Int. Cl. G06F 15/16

(52) U.S. Cl. 709/206; 709/230; 709/203

(57) ABSTRACT

Presence determination, location determination, instant messaging, and mobile commerce are integrated into a functionally seamless system, which may be implemented as an added component of a wireless provider's network. Alternatively, the integrated system enables instant messaging and mobile commerce as a centralized gateway attached to the networks of a large number of wireless providers. The gateway facilitates a business model that advances beyond today's practices, in which individual wireless carriers enter into bi-lateral agreements with specific Internet content providers. The functionally integrated gateway disclosed empowers Internet services that require real-time information about wireless subscribers in order to conduct m-commerce or offer advanced messaging services. Optimization of a wireless network is also facilitated by taking network performance measurements, without using a special drive test team, via devices that are regularly using the network during standard network operation.

### CROSS REFERENCE TO RELATED APPLICATIONS

This application is a continuation-in-part of U.S. application Ser. No. 09/771,201, filed Jan. 26, 2001, pending, which claims priority under 35 U.S.C. § 119(e) from provisional application No. 60/178,142, filed Jan. 26, 2000. This application also claims priority under 35 U.S.C. § 119(e) from provisional application No. 60/268,977, filed Feb. 15, 2001. The Ser. No. 09/771,201, 60/178,142, and 60/268,977 applications are incorporated by reference herein, in their entireties, for all purposes.

### INTRODUCTION

The present invention relates generally to the field of wireless communications. More particularly, the present invention relates to enablement of instant messaging and location-based mobile commerce across Internet and diverse wireless network infrastructures.

### BACKGROUND OF THE INVENTION

There are two major technical fields that have shown explosive growth over the past few years: the first is wireless communications and the second is use of data services, particularly the Internet. The growth of wireless communications has been astounding. Twenty years ago, there was virtually no use of wireless communications devices such as cellular phones. In contrast, the market penetration for wireless devices in the U.S. in 1999 was 32 percent. The current forecast is that 80 percent of the U.S. population will be wireless subscribers by 2008. Likewise, current and expected adoption of data services is phenomenal. Interestingly, wireless communications and data services are beginning to converge.

An example of this convergence is found in Instant Messaging (or “IM”). Originally an Internet-based text communication technology, IM will soon be integrated with wireless networks. It remains to be seen how smoothly this integration will proceed. Presence detection is an important element of any IM solution because an essential aspect of the IM technology is the detection of whether the members of each IM user's buddy list are present on the network. Although presence detection was fairly straightforward in the Internet environment, when the various wireless networks are to be integrated into the IM phenomenon presence is no longer so easy to establish comprehensively.

Thus, what is needed is an infrastructure technology to enable mobile IM services and provide for effective mobile buddy lists.

Another potential benefit of the integration of wireless networks with fixed IP networks, such as the Internet, is mobile commerce (also referred to as m-commerce). Thus far, mobile commerce has been severely limited. To date, mobile commerce has typically been subscriber-initiated, with the subscriber using a handset to locate a product or service. This approach is consistent with E-911 implementations, where the subscriber initiates a call that requires location information. However, for mobile commerce to be broadly successful this paradigm needs to be inverted. This inversion occurs because wireless devices (telephone handsets, personal digital assistants, etc.) are not suitable for “window shopping.” Merchants should have the ability to initiate promotions—on a permission-oriented basis—just as they do with other media.

In the next three years, the number of m-commerce providers is expected to grow from almost zero to more than 18,000 worldwide. In addition, traditional retailers will also seek to engage mobile customers. The current model of bi-lateral agreements cannot scale to meet the demands of m-commerce, messaging, and traditional retail. A centralized gateway, where subscriber information can be sold (on a permission-oriented basis) to firms that require such information, would be an advantageous advance

Thus, what is needed is a centralized gateway where subscriber information can be sold, on a permission-oriented basis, to commercial firms.

The availability of location information concerning the wireless handsets is important to the enablement of mobile commerce. Although handset location information is not strictly required for mobile commerce to occur, it certainly facilitates the establishment of an effective m-commerce campaign.

Wireless carriers worldwide are preparing to offer location-based services to their subscribers. At the heart of these services is the Position Determining Equipment (PDE) which determines the location of a wireless device. The available PDE solutions employ several distinct methods of location determination: triangulation of RF signals among base stations; RF fingerprinting; and, embedded GPS in the wireless device. Regardless of the method employed, the PDE's most critical interface is to the Mobile Positioning Center (MPC), which routes emergency 911 voice calls and their associated location information to the local Public Safety Access Point (PSAP). The PDE also has an interface to a Location Proxy Server (LPS), which makes location information available to non-emergency third parties outside the wireless network.

There is a trend in the industry to combine the MPC and the LPS into a single platform: both systems route voice calls with embedded location information to third parties. However, there are good reasons that this conventional trend should be reversed and the MPC and LPS should be decoupled. Whereas the MPC performs the proven, stable function of routing emergency calls to the PSAP, the LPS is expected to evolve rapidly to accommodate the massive demands of Internet-based businesses and services. Perhaps most importantly, the LPS must accommodate merchant-initiated transactions, which should become a significant aspect of mobile commerce but cannot be provided by voice call-driven MPC technology. In the same way that Home Location Registers (HLRs) have been decoupled from MSCs—allowing “intelligence” to be decoupled from switching fabric—the LPS should be decoupled from the MPC and allowed to evolve into a highly intelligent engine responsible for making wireless Internet access relevant, personal, and timely.

A number of companies (e.g., FolloWap, OpenWave, SignalSoft, CTMotion, Air2Web, AirFlash, Ericsson's “Oz,” InfoSpace, WindWire, OpenGrid, Aether Systems, 724 Solutions, MessageVine, Lucent, Nortel, Nokia, Quickdot, Xypoint, Cellpoint, just to name a few) currently promise technologies that will provide some form of IM or m-commerce solutions for wireless handsets to communicate with Internet-connected users. However, none of these companies have been able to develop a system that integrates presence determination, location determination, Instant Messaging, and mobile commerce.

Thus, what is needed is a an infrastructure technology that allows the integration of presence determination, location determination, Instant Messaging, and mobile commerce.

### SUMMARY OF THE INVENTION

Accordingly, one aspect of the present invention is the integration of presence determination, location determination, Instant Messaging, and mobile commerce into a functionally seamless system. This integrated Presence, Location, Instant messaging, and Mobile commerce (or “PLIM”) system may be implemented as an added component of a wireless provider's network.

Alternatively, a farther aspect of the invention is the integration of presence determination, location determination, Instant Messaging, and mobile commerce as a centralized gateway that may be attached to the networks of a large number of wireless providers.

The gateway arrangement according to this aspect of the invention facilitates a business model that represents a step forward from today's practices, in which individual wireless carriers are entering into bi-lateral agreements with specific Internet content providers. The PLIM gateway generates revenues from Internet services that require real-time information about wireless subscribers in order to conduct m-commerce or offer advanced messaging services. The gateway may then share the revenue generated through the sale of subscriber information with the participating wireless carriers that host the subscribers.

The PLIM gateway makes wireless subscriber presence, location, and profile information available on a 100% permission-oriented basis to Internet services. The PLIM gateway obtains subscriber information through direct electronic connections into wireless carrier networks. These connections are non-intrusive and pose no risks to the wireless carriers. Raw data collected from carriers is formatted and cached inside the PLIM gateway, and made available to registered Internet services through an electronic Internet-based interface.

Another aspect of the present invention is the enabling of true merchant initiated mobile commerce. This is made possible due to the integration of location information with a facility to manage marketing campaigns and a subscriber privacy management database. This ensures that the mobile commerce is conducted so that merchants obtain efficient marketing service and subscribers are subject only to marketing that they have expressly consented to.

Additionally, another aspect of the invention is the implementation of network optimization and performance measurement features to enable network operators to measure the performance and increase the efficiency of their networks.

It is an object of the present invention to provide integration, for one or more wireless networks, of presence information, location information, Instant Messaging, and mobile commerce.

It is another object of the present invention to provide integration of Instant Messaging and mobile commerce as a central gateway servicing the needs of multiple wireless networks.

It is yet another object of the present invention to provide integration of Instant Messaging and mobile commerce as a dedicated system servicing the needs of only a single wireless network.

It is still another object of the present invention to enable merchant initiated mobile commerce by integrating information about wireless subscribers' location, presence, and privacy choices.

Additional objects and advantages of the present invention will be apparent in the following detailed description read in conjunction with the accompanying drawing figures.

### BRIEF DESCRIPTION OF THE DRAWINGS

FIG. 1 illustrates a block diagram view of the architecture of a PLIM system according to the present invention.

FIG. 2 illustrates the flow of signals via the PLIM system of the present invention when subscriber-initiated location-sensitive Web browsing is practiced.

FIG. 3 illustrates the flow of signals via the PLIM system of the present invention when merchant-initiated mobile commerce is practiced.

FIG. 4 illustrates an initial registration process for effecting subscriber provisioning.

FIG. 5 illustrates a preference selection process for effecting subscriber provisioning.

FIG. 6 illustrates an updating process for maintaining subscriber provisioning.

FIG. 7 illustrates a carrier specific PLIM server implementation.

FIG. 8 illustrates a PLIM system implemented as a centralized gateway.

FIGS. 9 and 10 illustrate a system for network optimization and performance measurement, according to a further embodiment of the present invention.

### DETAILED DESCRIPTION OF THE INVENTION

One embodiment of the present invention is a computing platform that facilitates communications for wireless subscribers of a wireless network. The computing platform includes a presence module that maintains data concerning network presence of the wireless subscribers, as well as a location proxy module that maintains location data concerning physical location of the wireless subscribers. It also includes an instant messaging module connected to provide instant messaging service for the wireless subscribers utilizing the data concerning network presence. To enable mobile commerce, the computing platform further includes a campaign manager module connected to provide commercial message transmission to one or more of the wireless subscribers selected based on the data concerning network presence and the data concerning physical location.

Another aspect of the computing platform is a privacy database containing records of data permission settings corresponding to individual ones of the wireless subscribers. The data permission settings of the privacy database are used as a further basis on which the wireless subscribers are selected to be provided commercial message transmission.

Another aspect of the computing platform is that the presence module also maintains data concerning network presence of non-wireless instant messaging subscribers.

Another embodiment of the present invention is a network gateway for collecting presence information and location information concerning wireless subscribers of plural wireless networks, and for facilitating instant messaging and mobile commerce. The network gateway includes a presence module that maintains data concerning network presence of the wireless subscribers, as well as a location proxy module that maintains location data concerning physical location of the wireless subscribers. It also includes an instant messaging module connected to provide instant messaging service for the wireless subscribers utilizing the data concerning network presence. To enable mobile commerce, the network gateway further includes a campaign manager module connected to provide commercial message transmission to one or more of the wireless subscribers selected based on the data concerning network presence and the data concerning physical location.

The present invention also encompasses process embodiments for the conduct of mobile commerce. One process embodiment includes receiving a request from an approved merchant for current location information concerning a mobile subscriber, and verifying via a privacy database that the subscriber has given permission for the merchant to access the requested information. The process further includes obtaining current location information concerning the mobile subscriber from position determining equipment associated with a wireless network, and providing the subscriber's current location information to the merchant. By this process, the merchant is free to transmit to the subscriber personalized content based on the subscriber's current location information.

The integrated Presence Location Instant messaging and Mobile commerce (PLIM) system according to the present invention provides two salient advantages to a wireless carrier. One is the enabling of wireless instant messaging with “mobile buddy list” capability. The second is enabling of merchant-initiated mobile commerce. These applications hold great promise for immediate and untapped sources of revenue for wireless carriers.

IM is a revenue generating service. Instant messaging is a popular—perhaps indispensable—Internet service that wireless subscribers will pay to receive on their mobile devices. Even for carriers who do not bill separately for the IM service, the additional message traffic and airtime represent significant sources of new revenue on their existing infrastructure.

Enablement of mobile commerce (or “m commerce”) is also a revenue generator. A PLIM system according to the present invention makes subscriber presence, location, and interest information available to merchants who desire to initiate transactions with wireless subscribers. Carriers can generate multiple streams of revenue from the sale of presence and location information, as well as activate lucrative mobile commerce agreements with strategic partners.

In addition, the ability to offer the PLIM as a gateway, independent of a single network, allows several important advantages. Most importantly, it provides a virtual “one stop shop” so that merchants, customers, and network operators can establish a business relationship with a single entity that provides a seamless interface.

A PLIM system according to the present invention offers significant additional advantages to wireless carriers in terms of network optimization and performance measurement. Through its Presence Server, the platform allows other network elements to function more efficiently. For example, by indicating that a subscriber's phone is OFF, the PLIM system eliminates unnecessary and resource-consuming SMS delivery re-attempts. Similarly, the PLIM system can signal the Positioning Determining Equipment when a subscriber has registered in a different market, allowing the equipment to rapidly “re-locate” the subscriber.

The present invention ensures that mobile commerce is conducted in such a way that subscriber privacy is not compromised. The PLIM system provides for a 100% opt-in service. Subscriber information is firewalled inside the carrier's network, or inside a centralized gateway, depending on implementation options. Subscriber information is not provided to any third party without explicit permission. Subscribers have the ability to establish and change their permissions and preferences easily and frequently using both PC and wireless interfaces.

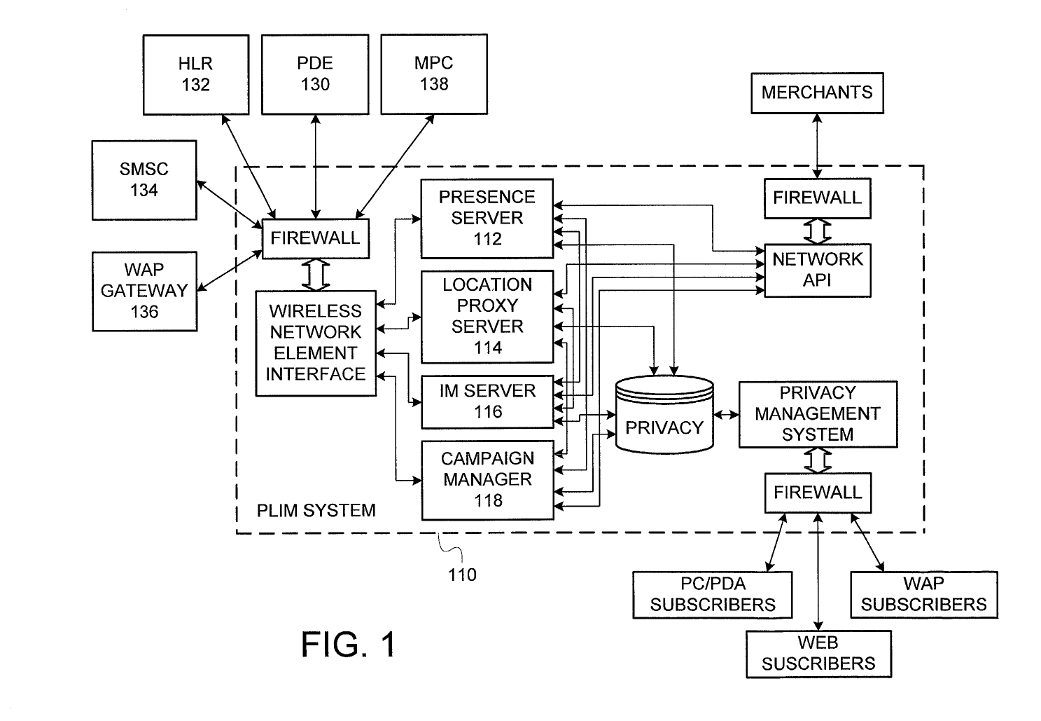

Referring to FIG. 1, a block diagram of the architecture of a PLIM system 110 according to the present invention is illustrated. One element of a system according to the present invention is the Presence Server 112. The Presence Server 112 determines whether a mobile device is ON or OFF in real-time. The Presence Server 112 inter-operates with system databases to allow sophisticated presence management.

Another element of a system according to the present invention is the Location Proxy Server (LPS) 114. The LPS 114 makes subscriber location, as determined by third party equipment (e.g., PDE), available to merchants and other external entities under controlled conditions. An additional element of a system according to the present invention is the IM Server 116. The IM Server 116 allows the wireless networks to send and receive instant messages from common IM platforms.

Another element of a system according to the present invention is the mobile commerce Campaign Manager 118. The Campaign Manager 118, allows wireless carriers to automatically deliver targeted messages and e-coupons on behalf of mobile commerce merchants.

Each of these elements 112, 114, 116, 118 may be implemented on separate servers, but need not be to practice the present invention. Conceptually, the Presence Server 112, the Location Proxy Server 114, the IM Server 116, and the Campaign Manager 118 may be implemented as software modules that may execute on separate physical machines, or on a single physical machine, at a common location, or remotely from one another, depending on operational convenience. In other words, these elements of the present invention are not dependent on the specifics of hardware implementation to provide the functions that make the present invention useful.

The integrated Presence Server 112, according to the present invention, determines the network presence of a wireless subscriber or IM user. The Presence Server 112 determines if a mobile phone or other mobile device is ON or OFF. It also determines if an Internet-based IM user is ONLINE or OFFLINE. The Presence Server 112 makes network presence information available between wireless networks and the Internet.

The simplest use of the Presence Server 112 is the instant messaging buddy list. Because the Presence Server 112 is able to determine if a wireless device is ON or OFF, traditional IM buddy lists can be extended to indicate whether “mobile buddies” are ON or OFF. Likewise, WAP applications and embedded software in the handset can indicate whether buddies are ONLINE at their PCs or at their wireless devices.

The buddy list is an integral part of the IM experience—it allows one to send messages to buddies who are online and therefore able to receive them instantly. But the buddy list is becoming a valuable application in its own right. It is useful to know if buddies, co-workers, staff, and others are ONLINE or have their phones ON. Particularly in mobile applications, merely knowing that a device is ON or OFF has intrinsic value.

The Presence Server 112 according to the present invention does much more than power the buddy list. It enables “presence management” in a world where there are many ways to be online, and individuals may carry several different wireless devices. Presence management allows subscribers to direct calls, messages, and data traffic to particular devices. Presence management extends well beyond ON or OFF information: subscribers may wish to indicate “ON-busy” or “ON-meeting” or “ON-emergency only” or any number of other personal settings. Subscribers may even desire for their presence information to be presented differently to different outside parties, for example “ON-busy” for co-workers but “ON-available” for spouse or supervisor. Moreover, Presence management preferences may change at different times of the day, and on different days of the week.

Presence information is also useful internally for the wireless network to streamline operations. One example involves the Short Message Service Center (SMSC) 134. The SMSC 134 does not know if a mobile device is ON or OFF, and therefore must employ a complex, multi-day message delivery and re-delivery algorithm to ensure that messages are delivered successfully. Using the PLIM system 110 according to the present invention, the SMSC 134 can query the Presence Server 112 before attempting to send a message, eliminating inefficient retry attempts.

Another example involves the Position Determining Equipment (PDE) 130 that many wireless carriers are expecting to deploy in the near future. Network-based PDE devices need to know the market where the subscriber is operating before they can locate the subscriber. If a subscriber moves from one market to another (for example, during a business trip), the PDE does not know where to begin searching for the subscriber. Using the present invention, the PDE can query the Presence Server to obtain market presence information, and then rapidly locate the subscriber.

The Presence Server communicates with other components of the PLIM system platform as well as external network elements in the wireless network.

Within the PLIM system platform, the Presence Server communicates with the Instant Messaging (IM) Server, the Campaign Manager, the Privacy Database, and the Network API components. The IM Server queries the Presence Server to determine if a subscriber's phone is ON or OFF so that accurate “mobile buddy list” information is available for the IM clients. The Campaign Manager queries the Presence Server to know if a particular subscriber's phone is ON or OFF before attempting to send a targeted mobile commerce message. The Presence Server queries the Privacy Database to ensure that an external entity requesting subscriber presence information is authorized to receive the information. Presence information is made available to approved external entities via “push” or “pull” through the Network API.

The Presence Server also communicates with the Position Determining Equipment (PDE), Home Location Register (HLR), Short Message Service Center (SMSC), and WAP gateway network elements in each of the wireless networks to which the PLIM system is connected. The PDE may query the Presence Server to determine the market in which a subscriber is operating. The Presence Server may extract wireless presence information from the HLR. The SMSC may query the Presence Server before attempting to deliver a short message to determine of the recipient's mobile phone is ON. The Presence Server provides wireless presence information to WAP-based IM clients for the “mobile buddy list.”

In order for presence management to be more useful in everyday life, network presence preferably indicates more than simple ON or OFF information. Table 1 illustrates the different types of wireless presence that are supported by a Presence Server of a system according to the present invention.

TABLE I

| WIRELESS DEVICE | |
|---|---|
| STATUS | INTERPRETATION |
| OFF | Phone is OFF. Determined automatically on power |
| | down. |
| ON - Available | Phone is ON and the subscriber is available to be |
| | contacted. |
| ON - Voice Call | Phone is ON, but the subscriber is engaged in a voice |
| | call. |
| ON - WAP | Phone is ON and subscriber is using the WAP instant |
| | messaging application. |
| ON - <user defined> | The phone is ON. The subscriber's status has been |
| | manually set by the subscriber. Predefined settings |
| | include: |
| | • DND (do not disturb) |
| | • Busy |
| | • Not available |
| | • Meeting |
| | • Emergency Only |
| | The subscriber may also create arbitrary status indicators |
| | consisting of alphanumeric characters. |

Likewise with the Internet, there are several variations of network presence. The PLIM system's Presence Server retrieves online presence from various IM servers (buddy list information) and makes it available to wireless subscribers on the WAP IM client application. Table 2 illustrates the different types of Internet presence that are supported by a Presence Server of a system according to the present invention.

TABLE 2

| INTERNET STATUS | INTERPRETATION |
|---|---|
| Offline | Internet customer has not turned on, or logged into, the instant |
| | messaging client application on her PC. |
| Online - Available | Internet customer has turned on, or logged into, the instant |
| | messaging client application on her PC. |
| Online - <user defined> | The Internet customer is running the instant messaging |
| | application and has selected one of the status indicators |
| | (typical): |
| | • Away |
| | • Extended Away |
| | • Emergency Only |
| | • DND (do not disturb) |

As IM moves into the wireless realm, presence information will undoubtedly become even more important. Using the status parsing as described above, presence information will be used for “availability management” in a world where people have multiple communication devices and can be accessed anywhere, anytime.

The IM-Anywhere Presence Server determines both Internet presence and wireless network presence, and makes this information available to entities on both networks. How presence is determined is explained as follows.

Determining Internet presence is straightforward: the Presence Server communicates peer-to-peer with IM servers. Internet presence information is made available to the Presence Server in the same way presence information is shared among IM clients worldwide. Currently, there is no uniform protocol for Internet-based instant messaging and presence, although an industry consensus is expected soon. The world's most common IM protocols are those used by AOL's Instant Messenger (AIM) and ICQ (also owned and controlled by AOL).

Determining wireless network presence is considerably more complex. Some of the key challenges are the following:

The underlying communication protocols of TIA/EIA-41 wireless networks currently do not natively provide presence indicators;

Accuracy is lost when unplanned network detachments occur, such as dead battery or roaming into analog service areas;

Real-time electronic connections into operational wireless networks are needed;

Wireless carriers are resistant to technical solutions that place a processing burden on operational network elements;

Wireless carriers will allow only a small number of external connections into their networks.

The PLIM system Presence Server according to the present invention overcomes these challenges using novel techniques, and by offering a wide variety of options for connecting into wireless network elements. The Presence Server is able to inter-operate with network elements from all major equipment manufacturers as well as Signaling System 7 (SS7) bearer networks. Table 3 indicates a few of the general presence determination techniques employed by the PLIM system. Co-pending U.S. application Ser. No. 09/771,201 discusses several additional techniques that may be used in accordance with the invention for presence determination.

TABLE 3

| CONNECTION | TYPE TECHNIQUE |
|---|---|
| Direct connection to | Interface via SS7 ports, TCP/IP, or proprietary ports (if offered |
| HLR | by HLR manufacturer). Both open and proprietary queries are |
| | utilized to infer presence. |
| SS7 network solution | Monitor the network's SS7 links and nodes for specific |
| | messages and combinations of messages that infer presence. |

Using these methods, as applicable, the Presence Server retrieves presence and location information asynchronously or synchronously. In asynchronous mode, the Presence Server queries (polls) the HLR or SS7 nodes whenever an update is needed. In synchronous mode, the HLR or SS7 nodes are configured to send presence status changes to the Presence Servers as they occur. In synchronous mode, subscriber presence information is “streamed” into the Presence Server (this is a “push” mechanism).

The Presence Server supports priority settings that allow presence updates to receive greater or lesser priority over other PLIM system traffic. Using an advanced prioritized event processing system, the PLIM system allows the wireless carrier to fine tune the Presence Server performance.

Even these sophisticated and proven techniques cannot provide accurate presence information in the event of an improper network detachment by the subscriber, i.e., the subscriber's battery dies. For these “corner condition” situations, the Presence Server employs heuristic techniques based on elapsed time and other conditions to infer the correct presence state.

Delivering of the presence information is another aspect of how the present invention operates. Presence information is made available to approved external users of the information through a secure Network Application Programming Interface (Network API). Approved users would appropriately include IM servers or unified messaging providers. The Network API allows both “pull” and “push” access by approved external users of the information.

An approved user can access presence information by subscribing to it. The user sends a subscribe request to the Presence Server using the Network API. If the subscribe request is approved, the Presence Server replies with a presence “atom” giving the current status of the wireless device. The Presence Server also agrees to notify the user each time the device's presence changes. The Presence Server will continue to notify the user of presence changes until the subscription has expired. If no expiration time is provided, the Presence Server assumes a default expiration period. If an expiration time of “zero” is provided, no subscription is created, and only a single presence atom is returned. This provides a user with a one-time presence fetch capability.

The integrated Location Proxy Server (LPS) of the PLIM system according to the present invention distributes real-time subscriber location information to platforms inside the wireless network and to third parties outside the network through the Network API. The LPS connects directly to a wireless carrier's Position Determining Equipment (PDE) and Mobile Positioning Center (MPC). Using the Network API, the LPS makes location information available for both “push” and “pull” access by the platforms and third parties that require location information. As with the other integrated services in the PLIM system platform, the LPS utilizes the Privacy Management System and its associated database to ensure the privacy of subscriber location information.

The PLIM system LPS is responsible for retrieving, formatting and processing, and delivering location information to the platforms that require it. Some of these platforms are certainly located outside the network (e.g., Web URL, m-commerce merchant). On the other hand, some of these platforms (e.g., the IM Server, the Campaign Manager) are optionally located either inside the wireless carrier's network or outside it at a central gateway location, for example.

The LPS has four basic functions: (1) retrieving location information from the PDE, (2) retrieving location information from other network elements, (3) formatting and processing location information, and (4) delivering location information.

To retrieve location information from the PDE, the LPS has a secure, electronic connection to the PDE via an API. The API is accessible over TCP/IP and employs the J-STD-036 protocol. The PDE API supports both a one-time query from the LPS as well as continuous streaming of location updates to the LPS.

It may also be useful to retrieve location information from other sources. Networks which do not have PDE should have coarse-grain location information available in other network elements. For example, some HLRs and MSCs indicate a subscriber's current serving cell or sector. This information is retrievable by the PLIM system's LPS.

The LPS formats and processes location information received from the PDE or other network element into a format that is acceptable to the requesting platform. Final formats are useful in the form of (1) latitude-longitude pairs with associated circular probability error (CEP), (2) zip code, (3) city identifier, or (4) Geographic Markup Language (GML) code. In order to produce a final format location “atom,” the LPS converts data from the PDE or network elements using geocoding techniques (i.e., convert sector ID into zip code). The wireless carrier must load network geography data, such as BTS locations, into the LPS database.

The LPS delivers location information to platforms outside the wireless network using the Network API. Location information can be provided in response to individual queries, or it can be streamed continuously to the external platforms. The LPS also provides location information to services inside the wireless network using TCP/IP messaging inside the carrier's firewall.

There are many scenarios under which the LPS provides location information to platforms inside and outside the wireless carrier's network. The following examples illustrate the two most common scenarios: subscriber-initiated location-sensitive Web browsing, and merchant-initiated mobile commerce.

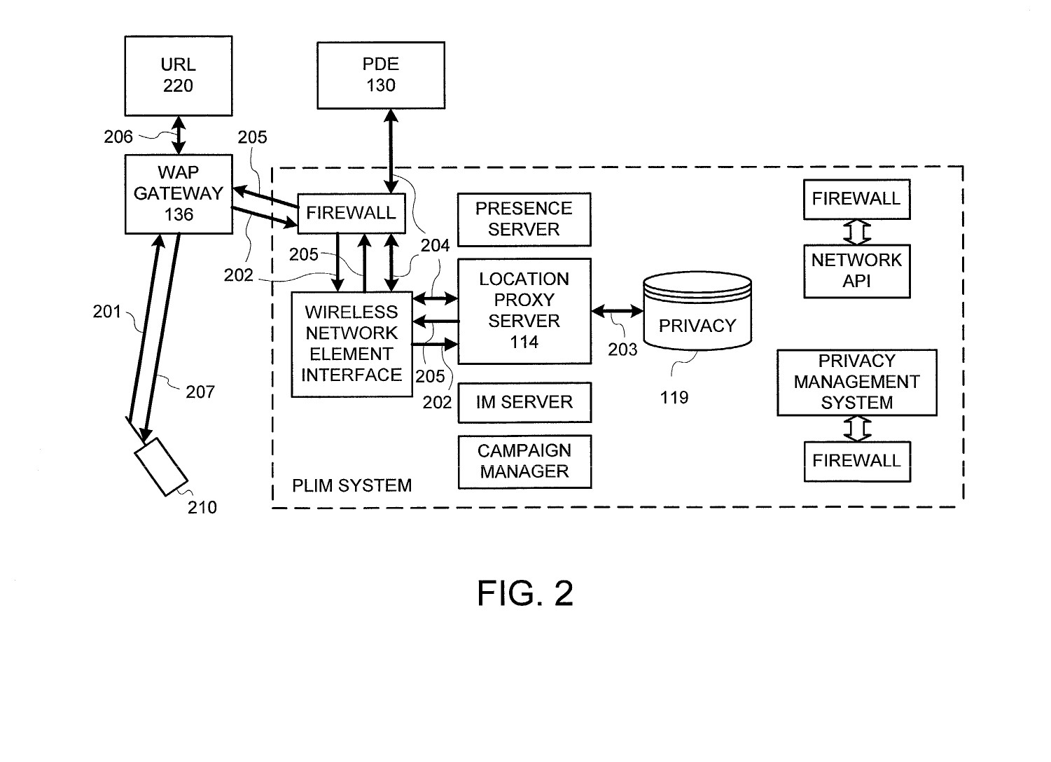

Referring to FIG. 2, subscriber-initiated location-sensitive Web browsing is illustrated. The process is initiated when a wireless subscriber 210 uses a WAP browser to request 201 location-sensitive information (e.g., driving directions) from a Web service (URL) 220. The WAP Gateway 136 automatically recognizes that location information is needed and queries 202 the PLIM system's LPS 114 for the most recent location information on the subscriber. The LPS verifies 203 that the privacy database 119 reflects that the subscriber has given permission for her location information to be provided to the Web service 220. If current location information is not available, the LPS 114 queries 204 the PDE 130 to obtain it. Alternatively, the PDE 130 may already be configured to “stream” location updates into the LPS 114. The LPS 114 provides 205 the subscriber's location information to the WAP Gateway 136. The WAP Gateway 136 embeds the location information into the requested URL and forwards it 206 to the Web service 220. A location-sensitive response from the Web service 220 is returned 207 to the subscriber 210 via the WAP Gateway 136.

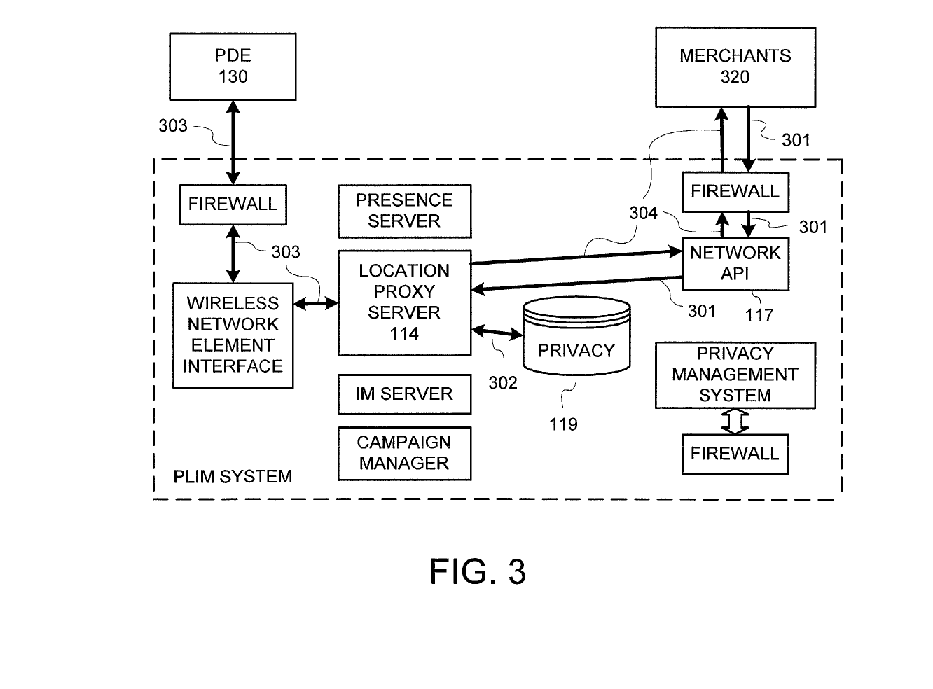

Referring to FIG. 3, merchant-initiated mobile commerce is illustrated. An approved merchant 320 with prior knowledge of a subscriber's phone number requests 301 the subscriber's current location information. The merchant 320 accesses the PLIM system's LPS 114 through the secure Network API 117, supplying a user ID and password. The LPS 114 verifies 302 that the privacy database 119 reflects that the subscriber has given permission for the merchant 320 to receive this data. If current location information is not available, the LPS 114 queries 303 the PDE 130 to obtain it. Alternatively, the PDE 130 may already be configured to “stream” location updates into the LPS 114. The LPS 114 provides 304 the subscriber's information to the merchant 320. The merchant uses this information to provide personalized content to the subscriber.

Referring again to FIG. 1, the LPS communicates with other components of the PLIM system platform as well as external network elements in the wireless network.

Within the PLIM system platform, the LPS communicates with the IM Server, the Campaign Manager, the Privacy Database, and the Network API. The IM Server queries the LPS for buddy location information to be displayed in the “mobile buddy list.” The Campaign Manager queries the LPS to determine if a subscriber's location should trigger the delivery of a targeted mobile commerce message. The LPS queries the Privacy Database to ensure that the subscriber's permission has been received before providing location information to any requesting service.

The LPS also communicates with network elements in each wireless network it services, including the Position Determining Equipment (PDE) 130, the Mobile Positioning Center (MPC) 138, the WAP Gateway 136, and other network elements. The LPS receives real-time location information from the PDE. The PDE must provide a secure API utilizing the J-STD-036 protocol. The LPS may receive location information indirectly via the MPC in some network architectures. The LPS provides subscriber location information on a permission-oriented basis to the WAP Gateway, which in turn forwards the location information to location-sensitive Web services requested by the subscriber. The LPS may obtain coarse-grain location information from other elements in the wireless network, such as the MSC or the HLR, depending on the equipment and configuration.

Location information is made available to approved external users of the information through the secure Network API. Approved users might include traditional merchants, e-commerce companies, mobile commerce companies, wireless gaming companies, and wireless advertising firms. The Network API allows both “pull” and “push” access by approved external users of the information.

In a manner analogous to that described above concerning presence information, an approved user can also access location information by subscribing to it. The user sends a subscribe request to the LPS using the Network API. The subscribe request includes the desired level of location granularity. If the subscribe request is approved, the LPS replies with a location “atom” giving the current location of the wireless device. The LPS also agrees to notify the user each time the device's location changes. The LPS will continue to notify the user of location changes until the subscription has expired. If no expiration time is provided, the LPS assumes a default expiration period. If an expiration time of “zero” is provided, no subscription is created, and only a single location atom is returned. This provides a user with a one-time location fetch capability.

The PLIM system allows wireless carriers to offer their subscribers access to popular instant messaging services on their wireless devices. The features that have made instant messaging one of the Internet's most indispensable applications (i.e., sending and receiving instant messages in real-time, knowing when buddies are online, and knowing when buddies have their phones turned ON) are now available on wireless devices:

The IM Server allows wireless carriers to offer their subscribers access to popular, commercially available IM services such as AOL Instant Messenger, ICQ, MSN Messenger, Yahoo! Messenger, and others. Using their handheld devices, wireless subscribers are able to send and receive instant messages and buddy list information with other wireless subscribers and with Internet IM users. Likewise, Internet IM users are able send and receive instant messages and buddy list information with wireless subscribers.

For the wireless subscriber, instant messaging is provided either through a WAP client or through two-way SMS. In the WAP mode, the subscriber goes to a WAP page operated by her wireless carrier. This WAP IM client allows subscribers to read and compose instant messages, to create and manage buddy lists and group lists, and to observe real-time buddy status. Two-way SMS offers the same functionality through the standard SMS interfaces. Messages are read and composed using SMS, and buddy list updates may be provided as short messages. Web and Windows™ IM clients, where administrative functions such as buddy list creation and maintenance can be performed, augment both the WAP and the two-way SMS IM clients. The Web and Windows™ clients are optional for WAP users but required for SMS users, since SMS does not lend itself to administrative activities.

It is important to note that the term WAP is being used generically to refer to any wireless Internet protocol, including HDML and any future wireless Internet protocols that may be developed. The following examples are provided of some competing technologies that for the purposes of this patent will be referred to generically as WAP. For example, the Web content can be delivered as existing HTML Internet content for wireless devices as proposed by Spyglass' Prism technology or Japan's i-mode. As a further example, the content can be processed through a template model that reads existing HTML content and fits the data to a template optimized for various types of wireless phones such as the system proposed by Everypath.com. As another example, the data content can be delivered to a Palm Pilot or other PDA or handheld device that uses a proprietary protocol.

Messages and buddy list updates to and from the wireless clients (WAP and SMS) pass through the PLIM system's IM Server utilizing a conventional client-server communication process. The IM Server communicates with Internet-based IM services using server-to-server communication protocols. Although no standard server-to-server protocol has been adopted by the industry, and several known alternatives are useful, the use of Session Initiation Protocol (SIP) extensions is a preferred implementation, due to the maturity of the SIP protocol, the native support of presence information, and the decoupling of presence information from the message body. Of course, the IM Server may be satisfactorily implemented via any version of Instant Messaging and Presence Protocol (IMPP) that may eventually become a standard. The PLIM system is advantageously configured to have a flexible, template-driven interface to external IM servers, and it can readily adapt to changes in the protocol.

In the future, WAP and SMS may give way to new wireless operating systems, for example Compact HTML, or perhaps embedded IM and buddy list clients in wireless devices themselves. Because the IM Server may be implemented as infrastructure software, it is able to adapt to the changing protocols and operating systems with straightforward changes to its interface coder-decode templates. In effect, the IM Server is independent of the client platform used by the wireless subscriber.

For Internet IM users, sending messages and buddy list information to “mobile buddies” is as simple as creating a new entry in the buddy list indicating the buddy's mobile name. For example, if a buddy's Internet name is gstead, a new entry should be created called gstead-phone or gstead-pda. The mobile buddy name is then associated with an Internet address that terminates at the IM Server. When messages are sent from the Internet user, they are received at the IM Server and routed to the wireless subscriber's device. IM clients are enhanced to indicate both Internet and mobile status for each buddy, eliminating the need to create separate entries for mobile buddies.

A Web client and a downloadable Windows™ IM client are provided for use on desktop computers. The Web client is accessible via standard Web browser, provides full messaging and buddy list capability, and provides full IM administration capabilities (buddy list admin, group list admin, password admin). The administrative settings apply to the two-way SMS client. The Windows™ client is substantially identical to the Web client, but runs as separate Windows™ application.

Wireless subscribers can access several different IM clients from their handheld devices, including a WAP client and a two-way SMS client. The WAP client is accessible via a wireless device's WAP browser and allows messages to be composed, sent, read, stored, saved, or deleted. The WAP client displays buddy list and buddy status, and allows buddies to be added or deleted. The WAP client also displays group lists, and allows group lists to be created, edited, and deleted. It is preferred that the WAP client be implemented using Wireless Markup Language (WML) for optimal display on wireless device. The WAP client should reside either on a Web server inside a wireless carrier's firewall, or behind the firewall of a PLIM system gateway site. A two-way SMS client utilizes standard two-way SMS to send and receive text messages, and buddy status updates (ON-OFF, online-offline) are sent via SMS. No administrative functions are provided in the two-way SMS client.

The WAP client provides some IM features which uniquely address the needs of wireless subscribers. Notification of successful delivery of an instant message to a wireless subscriber is provided, as is automatic retry of instant message delivery. When retry fails, the instant message is automatically re-routed to an appropriate email address. As required by the situation, message content is automatically reformatted (i.e., HTML to ASCII). Another helpful (if optional) feature is a library of predefined messages and replies, saving the subscriber the time required to enter an alphanumeric message on the keypad (examples include: Invitation to chat, Invitation to voice call, Yes, No, Why?, when?, and I'll call in 5 minutes).

The IM clients provide a rich set of functions for creating and managing buddy lists and group lists. These functions are offered by the Web client and the Windows™ client, and partially by the WAP client, but they are not available using two-way SMS. Table 4 summarizes the buddy list and group list management capabilities of the clients.

TABLE 4

| FUNCTION | AVAILABILITY | DESCRIPTION |
|---|---|---|
| Add Buddy | WAP client, Web | Enter Internet email address and IM |
| | client, and | service; or |
| | Windows ™ client | Enter mobile IM address; or |
| | | Import from wireless PIM (if provided by |
| | | wireless carrier) |
| | | Optional: request permission to receive |
| | | wireless buddy's location information (if |
| | | available from buddy's wireless carrier) |
| | | Receive authorization to add buddy (if |
| | | required by buddy's IM service) |
| Edit Buddy Info | WAP client, Web | Change address and/or IM service |
| | client, and | Request permission to receive buddy's |
| | Windows ™ client | location inforrriation (if available from |
| | | wireless carrier) |
| | | Cancel receipt of buddy's location |
| | | information |
| Remove Buddy | WAP client, Web | Remove Internet or wireless buddy from |
| | client, and | buddy list |
| | Windows ™ client | |
| Buddy List | WAP client, Web | Status Information (Online, Offline, ON, OFF) |
| Display | client, and | Internet and wireless buddy status will be |
| | Windows ™ client | displayed using information provided by |
| | | buddy's IM service |
| | | For wireless buddies who are OFF, last |
| | | time ON will be displayed |
| | | Wireless Buddy Location Information |
| | | Location information may be manually |
| | | queried (if it was requested and |
| | | authorized at the time the buddy was |
| | | added) |
| | | Last manually retrieved location will be |
| | | displayed (if authorized by buddy) |
| | | Buddy List Sort Options |
| | | All online or ON buddies, followed by all |
| | | offline or OFF buddies |
| | | Alphabetical Order |
| Group Lists | WAP client, Web | Sort all group names alphabetically |
| Display | client, and | View member of one group sorted (i) |
| | Windows ™ client | alphabetically or (ii) all online or ON |
| | | followed by all offline or OFF |
| Search Buddy | Web client and | By name |
| List | Windows ™ client | By interests |
| Search IM Server | Web client and | By name |
| | Windows ™ client | By interests |
| Create Group | Web client and | Create group as host |
| | Windows ™ client | Assign a name to the group |
| | | All members of the group have access to |
| | | the group |
| Add Member to | Web client and | Add existing buddy from buddy list |
| Group | Windows ™ client | Enter Internet email address and IM |
| | | service; or |
| | | Enter mobile IM address; or |
| | | Import from wireless PIM (if provided by |
| | | wireless carrier) |
| | | Optional: request permission to receive |
| | | wireless member's location information |
| | | (if available from member's wireless |
| | | carrier) |
| | | Receive authorization to add member to |
| | | group (if required by member's IM |
| | | service) |
| Remove Member | Web client and | Only the group host or the member |
| from Group | Windows ™ client | herself may remove a member from a |
| | | group |

In order for privacy to have real meaning in the implementation of this invention, each wireless subscriber who activates instant messaging capabilities is required by the IM clients to use the PLIM system's Privacy Management System to establish her opt-in permission, preferences, optional personal information, and optional interest lists. Wireless subscribers use the Privacy Management System to establish their availability and to establish rules for sharing presence and location information. A subscriber may update these settings many times each day, or they may never change. It is entirely up to the subscriber to perform her personal presence management. The Privacy Management System is an integrated component of the PLIM system platform, and can be accessed directly from any of the IM clients.

The IM Server communicates with other components of the IM-Anywhere platform as well as external network elements in the wireless network.

Within the PLIM system platform, the IM Server communicates with the Presence Server, the Location Proxy Server, the Privacy Database, and the Network API. The IM Server queries the Presence Server to determine if a subscriber's phone is ON or OFF so that accurate “mobile buddy list” information is available for the IM clients. When an IM client requests the location of a buddy, the IM Server sends query to the Location Proxy Server, which responds with the buddy's location information. The IM Server queries the Privacy Database to ensure that buddy list add requests, group list add requests, and location information requests and are authorized. Instant messages and buddy list updates are sent to, and received from, external IM services using the Network API.

The IM Server also communicates with the Short Message Service Center (SMSC) and WAP Gateway network elements in each of host wireless networks it services. The IM Server sends and receives instant text messages through the SMSC. The SMSC provides a successful delivery notification to the IM Server, if the IM client requested such a notification. The IM Server sends messages, buddy list status information, and administrative information to the WAP IM client, which is in turn accessed by the subscriber via the WAP Gateway.

One of the most advantageous features of the PLIM system is its ability to offer merchant-initiated mobile commerce. Approved merchants, retailers, e-commerce companies, wireless advertising agencies, and others (collectively, “merchants”) can use the PLIM system to obtain information about subscriber presence and location, as well as send messages and e-coupons to the subscriber. The enormous promise of m-commerce revenue will not be realized until this capability is widely available. The alternative—waiting for the subscriber to initiate a transaction—doesn't take advantage of the impulse buying opportunity and is built on unrealistic expectations of wireless device usage.

At least three models for m-commerce have emerged to date. According to the first model, the merchant creates a WAP-enabled Web site with content or shopping opportunities for wireless subscribers. The Web site does not provide location-sensitive content. The wireless subscriber uses a WAP browser to visit the Web site and request content or conduct a transaction.

According to the second model, the merchant has an independent account with the wireless subscriber (for example, a stock trading account). Through this independent account, the merchant has private information about the subscriber, including her mobile phone number. The merchant determines the subscriber's presence or location information using a Network API, and then delivers a message directly to the subscriber using email or some other WAP or SMS message delivery service.

According to the third model, the merchant does not know the subscriber's identity or mobile phone number. The merchant would like to send a message or e-coupon to all subscribers with a particular set of interests. Moreover, the merchant would like to send the message or e-coupon only when the subscriber has her phone turned ON and is near the merchant's retail store.

These models range from completely subscriber-initiated (the first model) to completely merchant-initiated (the third model). The PLIM system is structured to solve the prior art challenges that block widespread use of the second and third models, which are incidentally the most commercially promising of the three. The Network API and the Campaign Manager represent access points by which merchants can initiate personal, relevant, location-specific transactions with wireless subscribers.

The Campaign Manager automates the delivery of targeted messages and e-coupons to wireless subscribers. The Campaign Manager is useful for merchants who: (i) do not know the identity of their prospective customers, but are interested in targeting specific interest groups, or (ii) may know the identity of their prospective customers, but do not have the communications infrastructure to deliver messages to those customers. The Campaign Manager identifies a group of target subscribers based on interests and permissions, and delivers messages or e-coupons to those subscribers only when certain location, presence, and timing criteria are met.

The Campaign Manager is administered by the wireless carrier and is only available to merchants who have entered into agreements with the carrier. The creation and execution of a campaign may be highly automated, or may be administered manually, depending on the desires of the wireless carrier and the complexity of the campaign.

A contact campaign is advantageously structured to have the following elements: a campaign definition, campaign dimensioning, campaign execution, and campaign reporting.

The merchant provides, either electronically through a Web interface, or to a sales representative, campaign definition parameters, such as (i) target interest areas or a list of known mobile device numbers, (ii) the message or e-coupon, (iii) the start date and time, and duration, of campaign, and (iv) any conditions that must be satisfied to trigger the delivery of a message or e-coupon to a subscriber. Such conditions may include presence, location, day of week, and time of day.

Concerning campaign dimensioning, the Campaign Manager queries the Privacy Database to determine the number of accessible subscribers who: (i) match the interest areas, and (ii) have given permission to receive messages from the merchant. Based on the number of accessible subscribers matching the merchant's criteria, the merchant may decide to proceed with the campaign or, alternatively, to widen or narrow the campaign criteria.

When the campaign is executing, the Campaign Manager monitors each target subscriber. As soon as the merchant's criteria are satisfied for a given subscriber, the Campaign Manager delivers the merchant's message or e-coupon using WAP or SMS.

At the conclusion of the campaign, the Campaign Manager produces a report that indicates the total number of targeted subscribers, the total number of targeted subscribers for whom the campaign criteria were satisfied and a message was delivered, and the total number of successful and unsuccessful message delivery attempts.

The Campaign Manager performs sophisticated and computational intensive calculations during the campaign execution stage. A campaign may target as few as 10,000 or as many as 1 million or more subscribers. The Campaign Manager must monitor each of the subscribers throughout the duration of the campaign to determine if the message delivery criteria have been triggered. Some criteria are known beforehand, such as the subscriber's interests. Other criteria, such as presence and location, must be monitored in real-time. Location poses a special complexity, since the subscriber's distance from a merchant may need to be computed.

Merchants who wish to conduct a message campaign must work closely with the wireless carrier to configure the campaign. The Campaign Manager provides a Web interface through the Network API. Using this interface, merchants can define and dimension campaigns, and submit them to the wireless carrier for approval and execution. This highly automatic method is appropriate for small to medium scale campaigns, for campaigns with simple message delivery criteria, and for repeat campaigns.

The PLIM system operator (e.g., a wireless carrier, or a central gateway facility) may elect to work personally with merchants to manually define, dimension, and launch campaigns. In this scenario, a representative of the operator meets with the merchant and enters the campaign information into the Campaign Manager using the Web interface herself.

The Campaign Manager communicates with other components of the PLIM system platform as well as external network elements in the wireless network.

Within the PLIM system platform, the Campaign Manager communicates with the Location Proxy Server, the Presence Server, the Privacy Database, and the Network API. The Campaign Manager receives subscriber location updates via the LPS. The Campaign Manager receives subscriber presence updates via the Presence Server. The Campaign Manager queries the Privacy Database during the campaign dimensioning stage to build a list of accessible subscribers whose interest profiles and permissions make them viable candidates for receiving a message. The Campaign Manager offers a Web interface for creating, dimensioning, and launching campaigns. The Web interface is accessed through the Network API.

The Campaign Manager also communicates with the Short Message Service Center of any wireless networks it services. The Campaign Manager delivers messages to subscribers via the SMSC. The Campaign Manager also receives message delivery confirmations from the SMSC, which it uses when creating its campaign report.

The PLIM system platform includes a powerful Privacy Management System that safeguards personal subscriber information across each of the integrated services. Through a flexible opt-in interface, the Privacy Management System allows wireless subscribers to carefully manage their “wireless personas” so that services such as wireless instant messaging and merchant-initiated mobile commerce become welcome—even indispensable—wireless Internet applications.

Just as the PLIM system enables the delivery of targeted, timely, and personal information, it also ensures that private information is protected and that subscribers do not receive unwanted, intrusive external contacts. The Privacy Management System includes a secure database of subscriber identities, personal interest information, and permissions. This database is queried in real-time before personal information is provided to any external entity, and before any messages are delivered to the subscriber. The subscriber can access the Privacy Management System through the Web or through a WAP device at any time to modify their personal information.

The Privacy Management System is, in effect, a gatekeeper between the private information needed to make Internet services personal and relevant, and the vast world of merchants and messaging services who desire access to the subscriber. A description of the features and interworking of the Privacy Management System follows.

The centerpiece of the Privacy Management System is a Web interface where wireless subscribers provide personal information and establish the conditions under which they are willing to be contacted by outside parties. The information provided by the subscriber in the Privacy Management System is stored in a relational database that is part of the PLIM system platform. If the wireless carrier has separate databases that include partial information about its subscribers (i.e., basic identity, interests), this information can be loaded directly into the Privacy database rather than re-entered by the subscriber.

The Privacy Management System allows a “supervisor mode,” in which a subscriber's supervisor has the ability to control all aspects of the subscriber's account. This feature is useful for corporate wireless plans. Accordingly, there are three classes of information collected and stored by the Privacy Management System: (i) identity information, (ii) personal information and interests, and (iii) privacy management information.

Privacy management information describes the rules under which private information can be distributed, and the conditions under which a subscriber is willing to receive a targeted message. Table 5 describes the basic elements of privacy management available in the PLIM system.

TABLE 5

| PRIVACY CONTROLS | OPTIONS |
|---|---|
| May we tell others that | No. |
| your wireless device is | Yes. |
| ON or OFF? | Yes, but only the parties on the <include list>. |
| | Yes, all parties except those on the <exclude list>. |
| | For those parties for whom the answer is yes, which shall |
| | we indicate (check only one): |
| | ON or OFF only |
| | ON + status of the phone (idle, voice call, WAP mode) |
| | ON + <user-defined status> (please select from |
| | predefined list, or enter 14* alphanumeric) |
| May we tell others your | No. |
| location to within 100 | Yes. |
| meters? | Yes, but only the parties on the <include list>. |
| | Yes, all parties except those on the <exclude list>. |
| May we tell others what | No. |
| zip code you are in? | Yes. |
| | Yes, but only the parties on the <include list> |
| | (automatically includes all approved parties on the 100 |
| | meter list). |
| | Yes, all parties except those on the <exclude list> |
| | (automatically includes all approved parties on the 100 |
| | meter list). |
| May we tell others what | No. |
| city you are in? | Yes. |
| | Yes, but only the parties on the <include list> |
| | (automatically includes all approved parties on the zip |
| | code and 100 meter lists). |
| | Yes, all parties except those on the <exclude list> |
| | (automatically includes all approved parties on the zip |
| | code and 100 meter lists). |
| Please indicate your IM | For each IM service supported by the wireless carrier: |
| preferences. | |
| | Checkbox to indicate the subscriber has an account with |
| | the service; for each IM service checked by the subscriber: |
| | Provide IM address, screen name, account number |
| | Indicate preference for day or week, time of day |
| | Indicate preference for content type |
| | Indicate preference by send ID |
| Are you willing to | No. |
| receive messages from | Yes. |
| outside parties? | Yes, but only the parties on the <include list>. |
| | Yes, all parties except those on the <exclude list>. |
| | Yes, but only messages which are relevant to all of the |
| | following (as indicated by checkboxes): |
| | Specific interest |
| | General interests |
| | Income level |
| | Education level |
| | Birthday |
| | Gender |
| | Yes, but only the parties on the <include list> and only |
| | messages which are relevant to all of the following (as |
| | indicated by checkboxes): |
| | Specific interest |
| | General interests |
| | Income level |
| | Education level |
| | Birthday |
| | Gender |
| | Yes, all parties except those on the <exclude list> and |
| | only messages which are relevant to all of the following |
| | (as indicated by checkboxes): |
| | Specific interest |
| | General interests |
| | Income level |
| | Education level |
| | Birthday |
| | Gender |
| Please indicate which | Units of one hour. Multiple contiguous or non-contiguous. |
| time of the day you do | |
| not wish to receive | |
| messages. | |
| Please indicate which | Checkboxes for each day of the week. |
| days of the week you do | |
| not wish to receive | |
| messages. | |
| Is there a limit to the | Please check only one: |
| number of instant | Maximum messages per hour: (indicate quantity) |
| messages you are | Maximum messages per day: (indicate quantity) |
| willing to receive? | |
| Is there a limit to the | Please check only one: |
| number of promotional | Maximum messages per hour: (indicate number) |
| messages you are | Maximum messages per day: (indicate quantity) |
| willing to receive? | |

The <include list> and <exclude list> may include (i) predefined organizations selected by the wireless carrier, (ii) user-provided URLs, (iii) individuals identified by email or IM address. The wireless carrier has the ability to permanently exclude organizations (by URL) at its discretion. As to the user defined status indicators, the system automatically provides the following pre-defined status indicators: DND (do not disturb), Busy, Not Available, Meeting, Emergency Only. The system operator may add additional pre-defined status indicators if desired. As an optional service to the subscriber, it is possible to synchronize message blocking with external calendar programs, for example those provided by the wireless carrier's PIM.

Subscribers can access the Privacy Management System via secure Web or WAP interface. The expectation is that subscribers will use the Web interface for first-time configuration, and then use the WAP page for incremental or daily updates.

The subscriber determines which companies are allowed to received her presence and location information, and which companies may send a message. The company names shown on this screen are dynamically generated from a database. The PLIM system operator has complete control over the company names that appear (or do not appear) during the configuration process. Importantly, the subscriber may select times and days of the week when she is unwilling to receive messages.

The WAP interface to the Privacy Management System provides the same capabilities as the Web interface, and populates the same Privacy Database inside the PLIM system.

The Privacy Management System has a direct interface to the PLIM system's Privacy Database, as well as the ability to import data, via the System Management Module, from other databases inside the wireless carrier's network. The following illustration highlights the Privacy Management System, Privacy Database, and System Management Module as they relate to the PLIM system and its external environment.

Information provided to the Privacy Management System is loaded directly into the PLIM system's Privacy Database. The Privacy Database is accessed by all of the PLIM system integrated services, as described above.

The PLIM system also has a management module that allows the system operator to import relevant information directly into the Privacy Database, eliminating the need for data re-entry by the subscriber. Examples of the type of information a wireless carrier might elect to import directly into the Privacy Database include: (i) subscriber identities (i.e., name, wireless phone number, email address), (ii) links to subscriber PIM contents (i.e., calendar, contact lists), and (iii) links to previously entered interest information (i.e., news, traffic).

The PLIM system provides a standardized, secure Network API for external systems to exchange messages and signaling information with a wireless network. These external systems (which might include IM Servers, merchants, unified messaging providers, Internet content providers, wireless advertising firms, and wireless gaming service providers) are provided with an interface around which they can develop automated applications. For the wireless carrier, each of these entities represents both a source of value to subscribers as well as a source of revenue through bi-lateral business arrangements.

The Network API utilizes standard protocols and best-in-class security controls to prevent unauthorized access to wireless network elements. The PLIM system platform acts as a firewall to the wireless network elements, protects the privacy of subscribers, and ensures that external requests for information do not place an unacceptable load on operational network elements.

The PLIM system platform also creates a database of Transaction Detail Records which log every activity at the Network API, allowing the carrier to meter and audit usage for financial purposes.

The Network API (Network API) present an secure socket layer TCP/IP interface to external systems. External systems access the API through the steps of: (i) sending a properly encrypted login request, (ii) providing an authorized login ID and password (provided by the wireless carrier), and (iii) selecting an Network API service and beginning communications.

Table 6 shows how the Network API provides six separate services, or points of entry, for external systems.

TABLE 6

| SERVICE | DESCRIPTION | PROTOCOL |
|---|---|---|
| Instant Messaging | IM Server to server communications: | IMPP |
| | messages, presence, buddy list | |
| | administration | |
| Inter-carrier | SMS between different wireless networks | SMTP, SMPP |
| messaging | | |
| Presence | Non-IM requests for presence information | IMPP |
| Location | Requests for location information | IMPP with extensions |
| Campaign manager | Campaign creation, dimensioning, and | Web |
| | launch | |
| Privacy | Updates to the Privacy Management | Web, WAP |
| Management | System | |
| System | | |

The IM Server communicates with Internet-based IM services using server-to-server communication protocols. Several alternative protocols are under consideration by the IETF for a new Instant Messaging and Presence Protocol (IMPP). See RFCs 2778 and 2779. Thus, no standard server-to-server protocol has been adopted by the industry, at this time. Of course the PLIM system can be effectively operated according to any of the known protocols, however the preferred protocol is SIP extensions. SIP extensions is preferred due to the maturity of the SIP protocol; the native support of presence information; and the decoupling of presence information from the message body. In any case, the PLIM system has a flexible, template-driven interface to external IM servers, and is readily adaptable to changes in the protocol.

The IMPP interface allow external services to subscribe to both presence and location information. An approved external sends a subscribe request to the Network API. If the subscribe request is approved, the PLIM system sends a reply and agrees to notify the external service each time the device's presence or location changes. The PLIM system continues to notify the user of changes until the subscription has expired. If no expiration time is provided, the PLIM system assumes a default expiration period. If an expiration time of “zero” is provided, no subscription is created, and only a single reply is returned. This provides a service with a one-time fetch capability.

The PLIM system allows wireless subscribers to send SMS messages to subscribers on other wireless networks that support SMS. Messages originating in a network serviced by a PLIM system platform are directed from the SMSC to the PLIM system. The PLIM system routes the message to its destination network using SMPP (if direct access to the destination SMSC is possible) or otherwise using SMTP.

Multiple levels of security shield the Network API. The requirement of subscriber permission represents one level of security. The privacy database will not release information unless the subscriber's permissions and other restrictions are 100% satisfied.

Database security is a second level of security. All subscriber data is stored in an database, which provides internal security and encryption. For example, Oracle's Advanced Security Option provides industry standard checksum and encryption algorithms to ensure the privacy of the data transmitted over the network. Oracle also provides encryption on all system User IDs and passwords.

A third level of security is provided by user authentication via login IDs and passwords. A fourth level of security is provided by data encryption via a secure socket layer. A fifth level of security is network security that can be implemented via isolated subnets.

As a sixth layer of security, a firewall protects against: denial of service attacks such as Ping of Death, SYN flooding, Land attack, and IP Spoofing. Periodic firewall software updates ensure ongoing protection. A seventh level of security is physical security, which is ensured by locating the PLIM system hardware in a well-protected, trusted facility.

The are two aspects to service provisioning: wireless subscriber provisioning, and external service provisioning for merchants who desire access to the PLIM system through the Network API.

After the PLIM system is deployed in a wireless carrier's network, current subscribers may register for the service. The registration process allows the subscriber to activate wireless instant messaging as well as establish permissions for the release of personal information to merchants and other external services. The initial registration process requires special identity authentication. Future access to the system is granted through a standard login process.

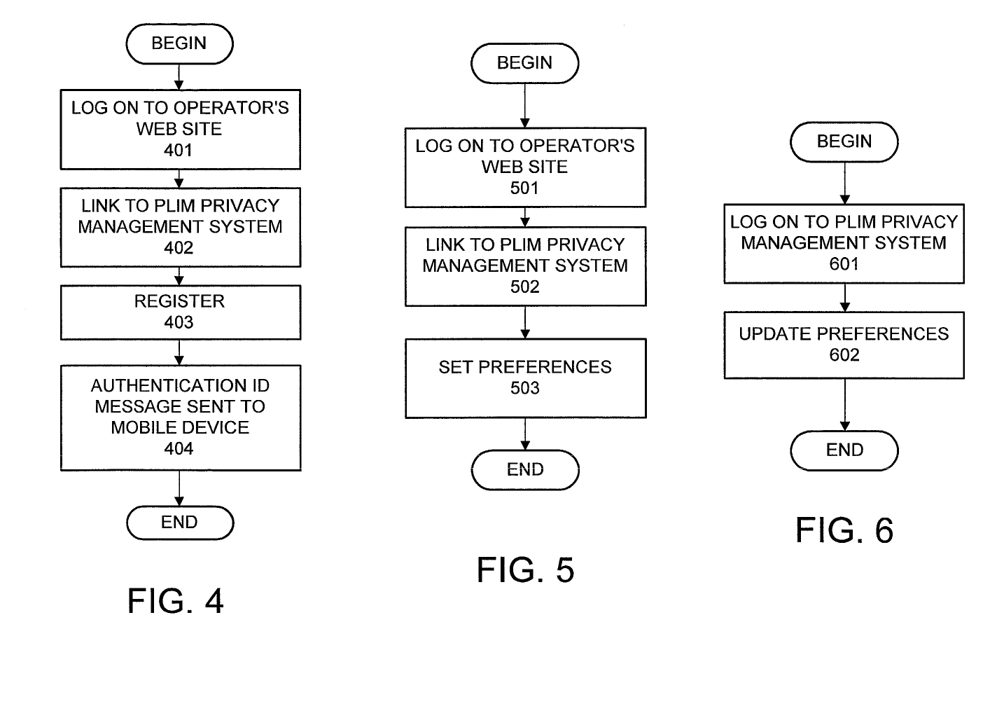

Referring to FIG. 4, an initial registration process for effecting subscriber provisioning is illustrated. The initial registration process is accomplished via Web or WAP interfaces. For initial service registration, the subscriber accesses the PLIM system through a hyperlink from the operator's Web page 401. The hyperlink leads the subscriber to the front end of the PLIM system Privacy Management System 402, where she provides basic identity information, including her name and mobile phone number 403. After providing this information, the subscriber is automatically directed to a Web screen informing her that an electronically generated password is being sent to her phone as a text message 404, and that she will not be granted further access to the system until she logs in using the new password. This system, known as Portal User Session Handling (PUSH), provides an acceptable level of confidence that only the owner of the wireless device will be establishing privacy controls for the device.

Referring to FIG. 5, a preference selection process for effecting subscriber provisioning is illustrated. Once the subscriber has received her initial password, she may login to the Privacy Management System 501, 502, where she will now have full access to the system. Here she may opt-in to wireless instant messaging and mobile commerce services, as well as establish her personal interests and communications preferences 503.

Referring to FIG. 6, an updating process for maintaining subscriber provisioning is illustrated. At any time after a subscriber has registered, she can access the Privacy Management System 601 through the Web or WAP interface to update her permissions and preferences 602.

The essential task of merchant provisioning is to provide approved merchants with accounts IDs, passwords, and connectivity information (i.e., IP address, encryption key).

According to an exemplary embodiment, the software architecture of the PLIM system utilizes two primary software subsystems: stack processors and database processors.

Stack processors initiate and manage communications between the system databases and external entities, such as wireless network elements and services. In addition, the stack processors handle all message routing and protocol translation. Once a stack processor receives a message, the message is translated from its native protocol into an internal object that can be handled by the database stored procedures. Protocol translation is performed using a custom translation engine, supported by message syntax templates. This allows new protocols to be integrated quickly, without need for new coding. The stack processors also enable message prioritization by the wireless carrier: messages from certain sources, for example presence updates from the HLR, may be assigned a higher priority level in the stack queuing algorithm than messages from other network elements.

The stack processors implement a communications system that provides software redundancy. Stack processes run in either a “distributed n” mode or a “master-slave” mode. A distributed n mode is used for computationally intensive operations that benefit from running in parallel across a distributed network. These processes have built-in redundancy and fail-over algorithms. If one process or machine dies, the transactions for that process are automatically distributed among the remaining machines. A master-slave mode is used for operations that are not computationally intensive and do not benefit from running on a distributed network. In this mode, two copies of the process run on separate machines. One acts as either the “master” or the “slave” for a given transaction. If one process dies or the machine fails, all transactions are automatically routed to the remaining process.

The database processors operate on a shared disk model in which all processors share all the data in the database. There is logically and physically only one database. This architecture allows for adding or substituting processors and storage devices to increase system performance without having to reconfigure the database. The architecture also enables flexible load balancing. Since all nodes have access to all the data, incoming connections and tasks can be evenly spread across all nodes.

The PLIM system is advantageously implemented using the Oracle Parallel Server technology, bundled with Sun's Solaris clustering capabilities, to provide wireless carriers with a widely deployed and proven solution. Oracle is currently the only carrier-class database platform that offers true parallel server capability, an essential component of the PLIM shared disk model. Oracle Parallel Server greatly enhances the scalability and high-availability capabilities of Oracle8i by combining the benefits of cluster scalability and availability with single system management capabilities. Clustered systems for database applications are fully exploited in Oracle Parallel Server to deliver a number of benefits.

One benefit is the protection from system failures due to high availability. Users can distribute database workloads across a cluster of servers and utilize all CPU and cluster memory resources to process application tasks. If one node fails, users can still access the database via other nodes in the cluster. The database automatically reconfigures to provide near continuous database processing, shielding users from system failures.

Another benefit is improvement in system performance due to cluster scalability. Oracle Parallel Server in Oracle8i sets a new standard for scaling applications with cluster load balancing and Cache Fusion technology, becoming a highly effective solution for increasing application throughput and system availability. Cache Fusion uses modern cluster interconnects to reduce disk I/O and exploits emerging high bandwidth, low latency interconnects to provide increased scalability.

A further benefit is a reduction in management costs provided by single system manageability. Single System View cluster management capabilities deliver perform-once-and-replicate-everywhere features and enable management of clusters as a single entity. By managing a single cluster database, repetitive tasks across servers can be consolidated into single management operations and automatically replicated across servers.

A PLIM system according to the present invention may be physically implemented a number of ways, but two specific exemplary system implementations are discussed: carrier specific and gateway.

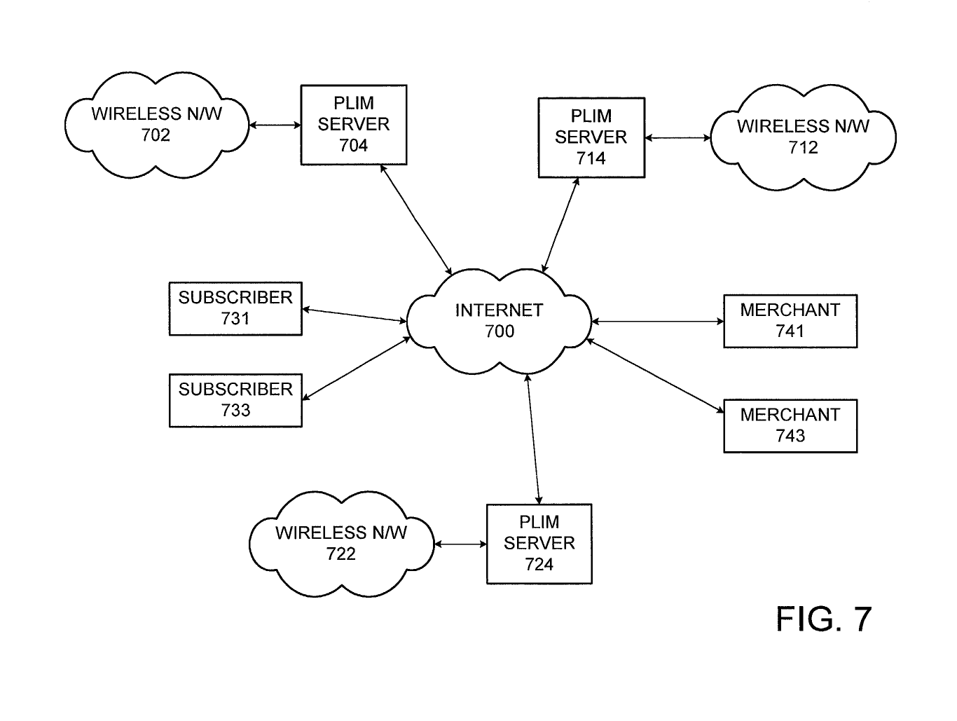

Referring to FIG. 7, a carrier specific PLIM server implementation is illustrated. The PLIM server 704 is connected (at least virtually, if not in a directly physical way) for dedicated service of a single wireless carrier's network 702. The PLIM server 704 is connected to the wireless network 702 it serves, as well as to the Internet 700 and to like PLIM servers 714, 724 serving other wireless carriers 712, 722 so as to facilitate availability of presence and location information between networks. Subscribers 731, 733 and registered merchants 741, 743 access the PLIM server 704 via the Internet 700.

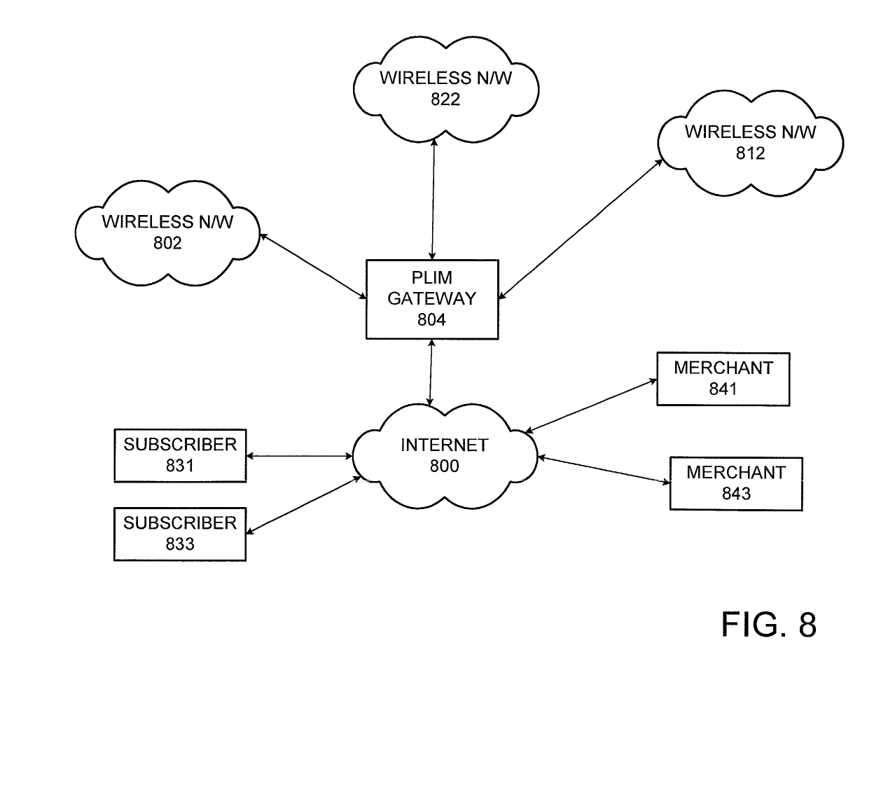

Referring to FIG. 8, a PLIM system implemented as a centralized gateway is illustrated. Any subscriber 831, 833, or any participating merchant entity 841, 843 may access the PLIM gateway 804 via the Internet 800. The PLIM gateway 804 is non-invasively connected to the wireless networks 802, 812, 822 of any consenting wireless carriers to facilitate availability of presence and location information. The PLIM gateway 804 connects to the HLR, MPC, SMSC, WAP gateway, and PDE (as applicable) of each of the wireless networks 802, 812, 822.

Concerning implementation examples, reference is made to the Invertix Corporation brochure “IM-Anywhere™ System Description” to be published subsequent to the filing of this application, a copy of which is filed herewith. The “IM-Anywhere™ System Description” brochure is incorporated by reference herein, in its entirety, for all purposes.

The PLIM gateway offers a potent value proposition to the Internet services that utilize its data, as well as the wireless carriers that participate in the PLIM gateway.

The Internet services (for example, m-commerce companies, instant messaging providers, and unified messaging providers) are revenue-producing customers of the PLIM gateway. These customers are enjoying unprecedented levels of growth and opportunity. M-commerce, in particular, is expected to grow from $140 million revenues worldwide in 2000 to more than $100 billion by 2004. Already, more than 1 billion messages per month are being delivered in wireless networks worldwide.

For m-commerce, messaging, and other Internet service providers, the PLIM gateway offers “one stop shopping” for real-time information about wireless subscribers, regardless of the host network. In addition, the gateway offers value-added service such short messaging with return receipt, as well as an electronic Campaign Manager. The electronic Campaign Manager allows targeted messages to be delivered to wireless subscribers only when certain conditions pertaining to presence, location, and profile have been satisfied.

Additionally, wireless carriers are becoming Internet Service Providers, and wireless itself is recognized as the new face of the Internet. Wireless carriers worldwide are struggling with Internet content and m-commerce for customer ownership, and carriers do not wish to see their airtime rates decline while others reap the rewards of m-commerce transactions. As a result, some carriers have entered into bi-lateral agreements with major Internet companies to create “walled gardens” of content for their customers. But m-commerce is growing at a rate that does not scale with bi-lateral agreements, and carriers will require a new business model in order to participate fully.

Customer ownership battles are a natural and predictable outcome of content distribution. For example, if a wireless customer has an E*Trade™ account, does the carrier own the customer or does E*Trade™ own the customer? Carriers can sidestep the debate by recognizing that they are the undisputed owners of information about their customers, such as presence, location, and profile information. This type of information, which is more akin to signaling than content, has tremendous value to providers of Internet services as well as traditional retailers. The PLIM gateway offers carriers the opportunity to generate revenue from this type of information, with the potential of selling the same piece of information many times.

For wireless carriers, the PLIM gateway is a cost-free method of generating new revenue. The PLIM gateway is an electronic “consignment shop” where wireless carriers can sell information about their subscribers. The PLIM gateway is a non-exclusive service, allowing carriers to continue to build bi-lateral relationships at will. As a sweetener, the gateway provides participating carriers with a Web-enabled software application that allows individual subscribers to set permissions and preferences related to the distribution of their personal information. In effect, the PLIM gateway acts a spam filter for subscribers, ensuring that their information is provided in strict accordance with their stated permissions and preferences.

Mobile commerce according to the present invention may be practiced without including the privacy management aspect to control access to subscribers. However the privacy management aspect provides important additional functional advantages that represent further advances over the prior art.

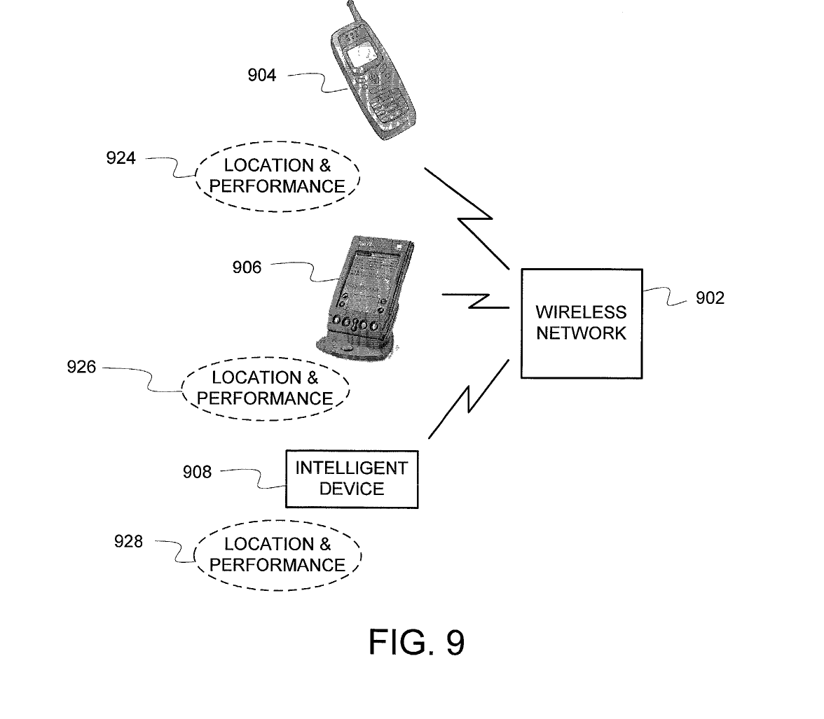

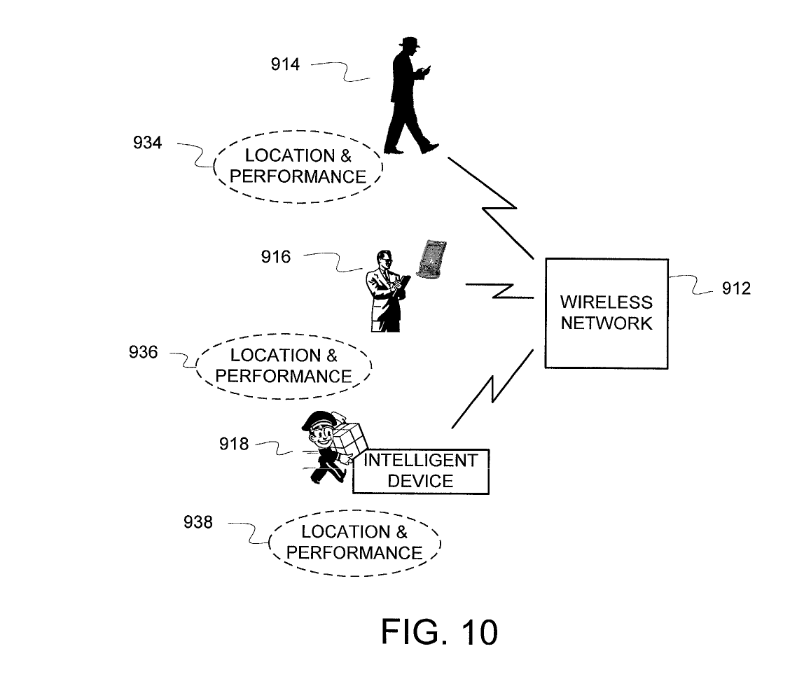

Referring to FIGS. 9 and 10, a system for network optimization and performance measurement, according to a further embodiment of the present invention is illustrated. As previously discussed, the present invention allows more efficient use of network resources because of its rich features. For example, the knowledge of presence information allows the sending of SMS messages only when the user's handset is ON. This results in more efficient network resource utilization allowing a network operator to make more money with the same amount of resources. Likewise, the organization of an m-commerce campaign which strategically targets the most receptive users requires significantly less network resources than a poorly designed campaign which delivers messages to a large untargeted group of users.

The examples cited above are somewhat passive in that they help optimize the network without actually measuring the network performance first and then making modifications to the network in order to optimize performance. This more active approach to network optimization involving performance measurement followed by optimization is already performed by many network operators by using drive test teams. This entails sending teams of skilled (and expensive) technicians and engineers to drive throughout the network coverage area with special equipment which uses the network resources (for example, by making test calls) while logging location and performance information. This collected data is post-processed and used to modify the network in order to optimize performance.

Unfortunately, this technique is very expensive and only provides a limited amount of data. For example, if the drive test is performed on one day and then a component of the network fails a week later, the resulting degradation in network performance may not be detected for a long time. This will result in poorer network performance and, consequently, less customer satisfaction. What is needed is a way to perform the drive test (or equivalent network measurement) without using a special drive test team. Optimally, the measurement should be taken by devices that are regularly using the network during standard network operation.

FIG. 9 shows a system for network optimization and performance measurement. The system includes a wireless network 902 and several wireless devices such as a wireless handset 904, wireless PDA 906, and a wireless intelligent device 908, just to name a few examples. Each of the wireless devices 904, 906, and 908 includes associated location and performance information 924, 926, and 928, respectively. The wireless devices 904, 906, and 908 are simply customer devices that are used on the network during regular operation. These devices can report their location information and performance information, such as RSSI, BER, FER, SQE, and the like, on a periodic basis to wireless network 902 where it can be stored in a database and post-processed. This allows standard users on the wireless network 902 to replace the drive test teams. This will produce better data since more devices can now be used to more frequently measure the network performance. Additionally, it eliminates the need to buy special drive test equipment and hire drive test teams.

The wireless devices 904, 906, and 908 can be used as drive test tools in a variety of ways. For example, Layer 3 information that provides performance information can be monitored for specific wireless devices along with location information. The location information can be generated in a variety of ways such as those disclosed in U.S. provisional application No. 60/268,977. In the alternative, the wireless devices 904, 906, and 908 can be modified with special embedded firmware that reports the location and performance information. As another alternative, wireless devices such as Java handsets can be used with a special application running in the background that reports location and performance information.

In contrast to the system of FIG. 9 that shows wireless devices that automatically report location and performance information, FIG. 10 shows a system for network optimization in which the user manually reports location and performance information. The system includes a wireless network 912 and several wireless users such as a wireless handset user 914, wireless PDA user 916, and a wireless intelligent device user 918, just to name a few examples. Each of the wireless users 914, 916, and 918 includes associated location and performance information 934, 936, and 938, respectively. The wireless users 914, 916, and 918 are simply customers that use the network during regular operation. The wireless network operator can set up a system to allow the user to immediately report problems such as dropped calls, blocked calls, or poor signal quality. This system may be referred to as the Customer Report Card (CRC) since it allows the user to point out network problems in real time and report them to the network operator. The advantage of manual reporting, rather than automatic reporting, is that the amount of reported data is greatly reduced and is only reported when there is a true network problem.

There are a variety of ways to implement the CRC system. The operator can have a special reporting phone number with menus and prompts similar to current PBX answering systems. Alternatively, the operator can have a special reporting phone number with a voice to text system that logs the results. As another alternative, the network operator can have a WAP or SMS based system that provides a menu for logging the problem. These are just a few examples of techniques for implementing the CRC.

Although FIGS. 9 and 10 show a system that can be seamlessly integrated with the PLIM system that was previously described, it is clear to those of ordinary skill in the art that the active network optimization systems described above are not dependent on the PLIM system and can be implemented independently.

The present invention has been described in terms of preferred embodiments, however, it will be appreciated that various modifications and improvements may be made to the described embodiments without departing from the scope of the invention.

What is claimed is:

1. A computing platform for facilitating communications for wireless subscribers of a wireless network, the computing platform comprising:
a presence module maintaining data concerning network presence of the wireless subscribers;
a location proxy module maintaining location data concerning physical location of the wireless subscribers;
an instant messaging module connected to provide instant messaging service for the wireless subscribers utilizing the data concerning network presence; and
a campaign manager module connected to provide commercial message transmission to one or more of the wireless subscribers selected based on at least one of the data concerning network presence and the data concerning physical location, wherein the wireless subscribers are provided with instant message service and mobile commerce service.

2. The computing platform for facilitating communications of claim 1, further comprising:
a privacy database containing records of data permission settings corresponding to individual ones of the wireless subscribers;
wherein the wireless subscribers are selected to be provided commercial message transmission based further on the data permission settings of the privacy database.

3. The computing platform for facilitating communications of claim 1, wherein the presence module additionally maintains data concerning network presence of non-wireless instant messaging subscribers.

4. A network gateway for collecting presence information and location information concerning wireless subscribers of plural wireless networks, and for facilitating instant messaging and mobile commerce, the network gateway comprising:
a presence module maintaining data concerning network presence of the wireless subscribers;
a location proxy module maintaining location data concerning physical location of the wireless subscribers;
an instant messaging module connected to provide instant messaging service for the wireless subscribers utilizing the data concerning network presence; and
a campaign manager module connected to provide commercial message transmission to one or more of the wireless subscribers selected based on at least one of the data concerning network presence and the data concerning physical location, wherein the wireless subscribers are provided with instant message service and mobile commerce service.

5. The network gateway of claim 4, further comprising:
a privacy database containing records of data permission settings corresponding to individual ones of the wireless subscribers;
wherein the wireless subscribers are selected to be provided commercial message transmission based further on the data permission settings of the privacy database.

6. The network gateway of claim 4, wherein the presence module additionally maintains data concerning network presence of non-wireless instant messaging subscribers.

7. A process for conducting mobile commerce, the process comprising:
receiving current location information concerning a mobile subscriber from position determining equipment associated with a wireless network;
receiving current network presence information concerning the mobile subscriber from a home location register associated with the wireless network;
maintaining profile and permissioning information concerning the mobile subscriber in a privacy database; and
transmitting to the subscriber personalized commercial content based on the profile and permissioning information concerning the mobile subscriber, and at least one of the subscriber's current location information and the subscriber's current presence information.
